(19) United States
(12) Patent Application Publication
(10) Pub. No.: US 2026/0007558 A1
(43) Pub. Date: Jan. 8, 2026

(54) Transfer Assistive Device and Apparatus

(71) Applicants: Nanyang Technological University, Singapore (SG); Tan Tock Seng Hospital Pte Ltd, Singapore (SG)

(72) Inventors: Wei Tech ANG, Singapore (SG); Lei LI, Singapore (SG); Wei Chuan LAW, Singapore (SG); Daniel WANG, Singapore (SG); Youlong WANG, Singapore (SG); Rohini SWAMINATHAN, Singapore (SG); Sui Geok Karen CHUA, Singapore (SG); Wee Keong Christopher KUAH, Singapore (SG); Geok Eng TOH, Singapore (SG); Dan WANG, Singapore (SG); Huiting ZHUO, Singapore (SG)

(21) Appl. No.: 18/993,198

(22) PCT Filed: Jul. 13, 2023
(86) PCT No.: PCT/SG2023/050492

§ 371 Date: Jan. 10, 2025

(30) Foreign Application Priority Data
Jul. 13, 2022 (SG) 10202250455R

(51) Int. Cl. A61G 7/10

(52) U.S. Cl. CPC A61G 7/1017; A61G 7/1046; A61G 7/1055; A61G 7/1065; A61G 7/1074

(57) ABSTRACT

An apparatus for assisting a patient, the apparatus includes: a base, a primary member, an interface member, and three or more attachment members. The primary member is coupled to the base at a coupling end, with the primary member extending along a longitudinal axis from the coupling end to a shoulder. The interface member is an elongate member defining a first axis. The interface member is coupled to the shoulder with the first axis extending transversely relative to the primary member. The three or more attachment members are coupled to the interface member and extendable to extend radially from the interface member. Each of the three or more attachment members is attachable via corresponding attachment elements to a sling. The three or more attachment elements and the interface member are collectively rotatable as a rigid body about the first axis.

### CROSS-REFERENCE TO RELATED APPLICATION

The present application is the national stage filing of International Application PCT/SG2023/050492, filed Jul. 13, 2023, which claims the benefit of priority to the Singapore application no. 10202250455R filed Jul. 13, 2022, the contents of which are hereby incorporated by reference in their entirety for all purposes.

### TECHNICAL FIELD

This application relates to an assistive device suitable for use in transferring a patient. More particularly, this application relates to devices that may be used to hoist, translate, and/or lower mobility-challenged people.

### BACKGROUND

Transferring an immobilized patient to and from a wheelchair or a bed has been ranked as one of the most physically challenging tasks that caregivers perform. This is particularly so in cases where “max assist transfer” is required, that is, when the patients have limited abilities to stabilize their upper bodies and often do not have enough leg strength to support their own body weight. Even with the use of conventional apparatus, at least two caregivers are required, e.g., one to operate the apparatus and another to stabilize the patient.

### SUMMARY

In one aspect, the present application discloses an apparatus for assisting a patient. The apparatus includes: a base, a primary member, an interface member, and three or more attachment members. The primary member is coupled to the base at a coupling end, with the primary member extending along a longitudinal axis from the coupling end to a shoulder. The interface member is an elongate member defining a first axis. The interface member is coupled to the shoulder with the first axis extending transversely relative to the primary member. The three or more attachment members are coupled to the interface member and extendable to extend radially from the interface member. Each of the three or more attachment members is attachable via corresponding attachment elements to a sling. The three or more attachment elements and the interface member are collectively rotatable as a rigid body about the first axis.

Preferably, at least three of the three or more attachment members are distributed along the first axis. Optionally, four of the three or more attachment members are disposed in pairs in mirror symmetry about a middle plane of the interface member. Preferably, the three or more attachment members are coupled with the interface member and biased towards an extended position, the extended position of any one of the three or more attachment members being one in which the one of the three of more attachment members is extended radially from the interface member.

### BRIEF DESCRIPTION OF THE DRAWINGS

Various embodiments of the present disclosure are described below with reference to the following drawings:

FIG. 1 is an exploded view of the device according to an embodiment of the present disclosure;

FIG. 2 is a perspective view of an interface member and attachment members of the device of FIG. 1;

FIG. 3 is a side view of the interface member and attachment members of FIG. 2;

FIG. 4 is a schematic perspective view of an apparatus according to an embodiment of the present disclosure;

FIG. 5 is a side view of the apparatus of FIG. 4;

FIG. 6 is a perspective view of a sling according to an embodiment;

FIG. 7 is a side view of the sling of FIG. 6;

FIGS. 8 and 9 are perspective views of an apparatus during operation according to another embodiment;

FIG. 10 is a perspective front view of the apparatus;

FIG. 11 is a side view of FIG. 10;

FIG. 12 is a perspective back view of the apparatus of FIG. 10;

FIGS. 13A to 13H are perspective views of a transfer process;

FIG. 14 is a perspective view of an apparatus in operation according to another embodiment of the present disclosure; and

FIG. 15 is a perspective view of the apparatus of FIG. 14.

### DETAILED DESCRIPTION

The following detailed description is made with reference to the accompanying drawings, showing details and embodiments of the present disclosure for the purposes of illustration. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance as generally understood in the relevant technical field, e.g., within 10% of the specified value.

As used herein, the term “and/or” includes any and all combinations of one or more of the associated listed items.

As used herein, “comprising” means including, but not limited to, whatever follows the word “comprising”. Thus, use of the term “comprising” indicates that the listed elements are required or mandatory, but that other elements are optional and may or may not be present.

As used herein, “consisting of” means including, and limited to, whatever follows the phrase “consisting of”. Thus, use of the phrase “consisting of” indicates that the listed elements are required or mandatory, and that no other elements may be present.

A detailed description of various embodiments of the present disclosure is provided below with reference to the appended drawings to aid understanding.

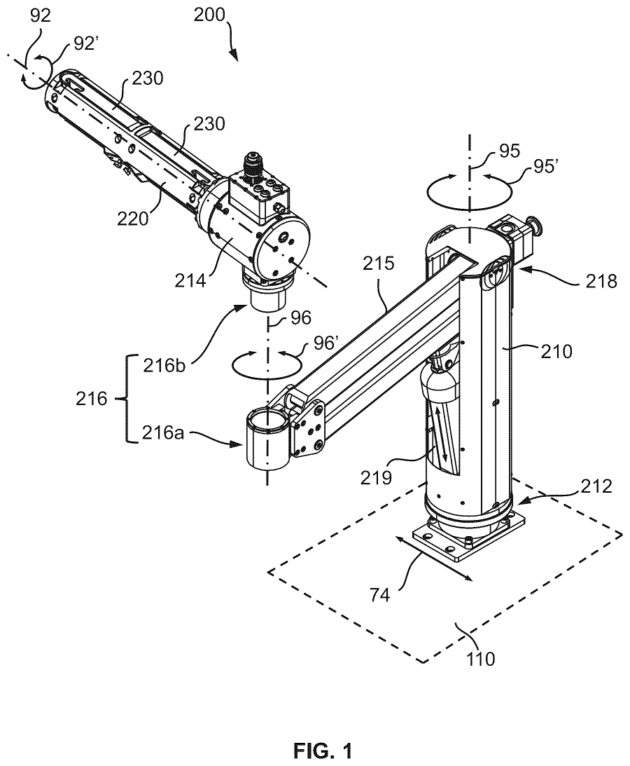

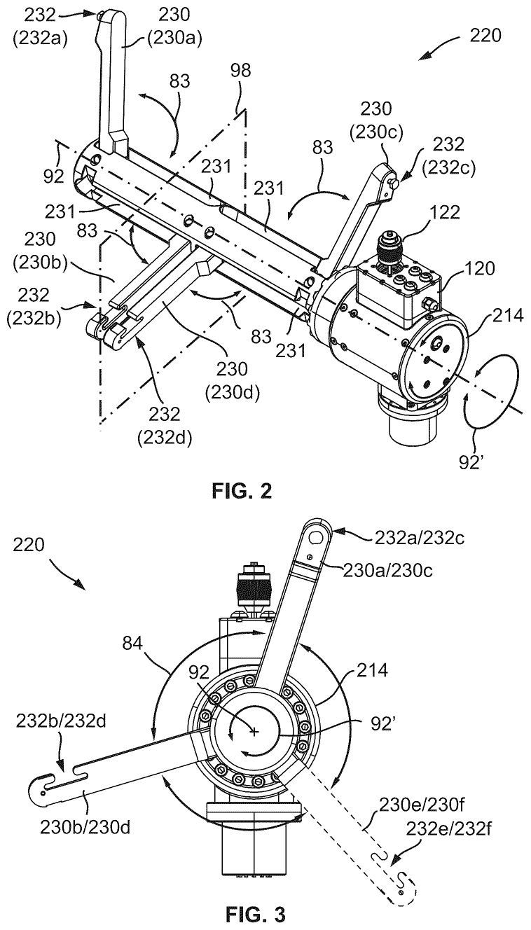

FIGS. 1 and 2 schematically illustrate a transfer device 200 according to one embodiment of the present disclosure, in which the device 200 can be used for transferring a patient between two support surfaces. The term “support surface” refers to a surface that can support the weight of a person or the patient, for example, a bed, a mattress, a wheelchair seat, a car seat, etc. One of the support surfaces may be a mobile apparatus, including but is not limited to a wheelchair or other assistive mobility devices, intended to be pushed by a person and/or powered for user-controllable travel and/or autonomous travel. More particularly, embodiments of the apparatus are useful for transferring a patient between a lying (flat) position and a seated position, e.g., a max assist transfer (e.g., partially dependent max assist or fully dependent max assist) between a bed and a wheelchair. It will be understood that although various embodiments of the device 200 and the apparatus 100 are described with respect to a max assist transfer, the same may also be used to assist persons who require only moderate assist transfer.

The device 200 may be integrated with a base 110. Alternatively, the device 200 may be configured as a modular unit, and configured to be interchangeably attached/detached from an existing base 110 by a user, e.g., a caregiver. The device 200 includes a primary member 210. In the embodiment illustrated, the primary member 210 includes a coupling end 212 that may be coupled to the base 110. In this embodiment, a secondary member 215 extends transversely from an upper end of the primary member 210. The primary member 210 and the secondary member 215 may be adapted from a robotic arm. The secondary member 215 may be articulated relative to the primary member 210 by an actuator. In this embodiment, a linear actuator 219 is provided to rotate the secondary member 215 about a shoulder 218, relative to the primary member 210, such that a far end 216a of the secondary member 215 (the far end 216a and a joint 216b may also be collectively referred to as an elbow 216) may be positioned at different elevations/height relative to the base 110. The mechanism of the secondary member 215 ensures that the far end 216a and any member(s) (e.g., the joint member 216b, the interface member 220, etc.) coupled to the far end 216 is (are) always parallel at any elevation/height relative to the base 110. In case of any malfunction, the secondary member 215 will remain static relative to the primary member 210 to prevent a suspended patient from falling from the device 200 therefrom. For example, in a sudden power outage that occurs when the device 200 is in use, the secondary member 215 will remain stationary or be locked in a stationary pose relative to the base 110, and the interface member 220 will remain parallel and stationary relative to the base 110. As a result, the patient remains safely suspended and supported by the device 200 in a stationary position relative to the base 110. In another example, if the caregiver assisting patient in the transfer unexpectedly loses hold of the patient, the device 200 alone suffices to keep the patient safely supported. Advantageously, the patient suspended by the device 200 will not swing or spin about uncontrollably in the absence of a caregiver assisting in the transfer process.

An interface member 220 may be coupled to the secondary member 215 at the elbow 216. The interface member 220 may be configured to pivot 96′ about an elbow axis 96 defined by the elbow (joint) 216, relative to the secondary member 215. The shoulder 218 serves as a sturdy mounting post for the elbow 216. In some examples, bearings and a DC motor with a worm gearbox may be housed in the elbow 216, allowing the interface member 220 to be controllably rotated. The gearbox may be configured to allow a high rotational torque to be transmitted to the elbow 216 with minimal noise.

FIG. 2 illustrates an embodiment of the interface member 220. The interface member 220 is substantially elongate and defines a first axis 92 along its axial length. The interface member 220 includes an actuating end 214 disposed on the elbow 216. The actuating end 214 includes a rotary mechanism which enables controllable angular displacement 92′ of the interface member 220 about the first axis 92. The elbow 216, the shoulder 218, and the coupling end 212 of the primary member 210 cooperatively provide multi-axial translation and/or rotation of the interface member 220 over a relatively large three-dimensional workspace. In the embodiment illustrated, the device 200 may be configured with five joints of which three may be actuated joints or powered joints.

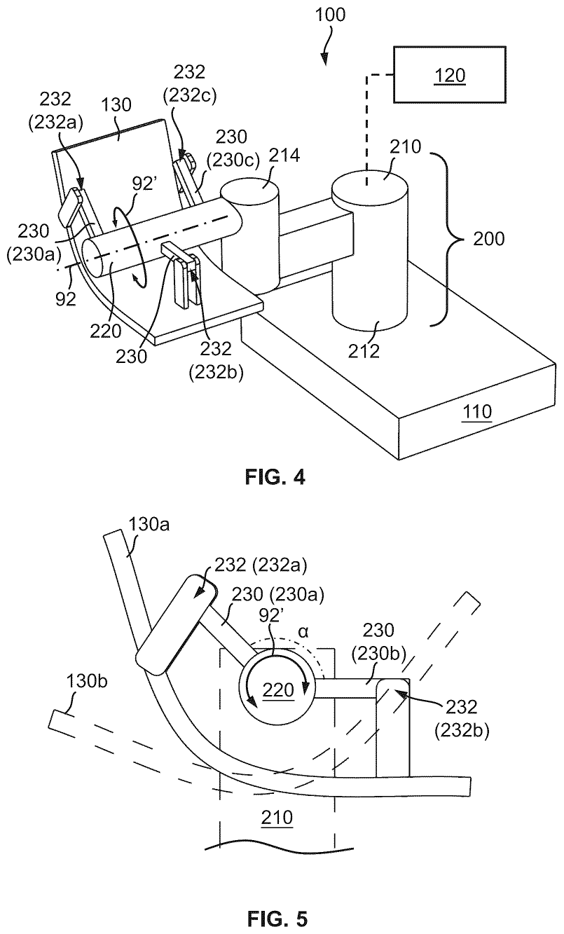

The interface member 220 includes multiple attachment members 230. Each of the attachment member 230 is coupled to the interface member 220 and includes at least one attachment element 232. In use, the attachment element 232 may be attached to a part of a sling 130 (FIG. 4), i.e., the attachment elements 232 may provide respective hoisting attachments to the sling 130.

In some embodiments, as illustrated in FIG. 2, each of the attachment members 230 may be pivotable 83 relative to the interface member 220. The interface member 220 may include a plurality of slots 231 disposed therein, each slot 231 being sized to substantially or at least partially receive a respective one of the attachment members 230. When an attachment member 230 is not in use, the attachment member 230 may be pivoted such that the attachment member 230 is disposed within the respective slot 231 in the interface member 220. When the attachment member 230 is in use, the attachment member 230 may be pivoted or flipped out of the respective slot 231 such that the attachment member 230 is directed outward in an extended position as illustrated in FIGS. 2 and 3. In use, the attachment member 230 may be transversely disposed or extending radially relative to the first axis 92, i.e., relative to the elongate interface member 220.

In this non-limiting example, the interface member 220 includes two pairs of attachment members 230. The first pair of attachment members 230 may include attachment members 230a/230c, and the second pair of attachment members 230 may include attachment members 230b/230d. Preferably, the attachment members 230 extend substantially parallel to the first axis 92 when the attachment members 230 are received in the respective slots 231. When the attachment members 230 are in an extended position, the respective attachment elements 232a/232b/232c/232d are exposed for coupling with a sling 130. Non-limiting examples of the attachment element 232 include a hook, a knob, a buckle, a strap, a releasable fastener, etc.

Therefore, upon a rotation 92′ of the interface member 220 relative to the actuating end 212 of the primary member 210, the attachment elements 232a/232b/232c/232d are collectively rotatable about the first axis 92 relative to the actuating end 212, thereby tilting the sling 130. That is, the sling 130 may be rotated as a rigid body about the first axis 92. Therefore, when the device 200 is in operation with a patient received in the sling 130, an axial rotation of the interface member 220 about the first axis 92 may vary or manipulate an inclination angle of the patient. That is, by rotating the interface member 220 about the first axis 92, the patient may be supported from a lying or horizontal position to an upright seated position or vice versa.

In some embodiments, the first pair of attachment members 230a/230c may be disposed in mirror symmetry about a middle plane 98 of the interface member 220, such that the interface member 220 is symmetrical about the middle plane 98 when the attachment members 230a/230c of the first pair are both retracted or both extended.

In some embodiment, the second pair of attachment members 230b/230d may be disposed in mirror symmetry about the middle plane 98 of the interface member 220, such that the interface member 220 is symmetrical about the middle plane 98 when the attachment members 230b/230d of the second pair are both retracted or both extended. Preferably, the attachment elements 232a/232b/232c/232d are also symmetrically disposed about the middle plane 98 to facilitate a generally equal distribution of weight along the interface member 220.

In some embodiments, the interface member 220 may further include a third pair of attachment members 230e/230f. The third pair of attachment members 230e/230f may include respective attachment elements 232e/232f. The attachment members 230e/230f may be pivotably coupled to the interface member 220 between an extended position and a retracted position. Preferably, in both the extended position and the retracted position, each pair of the attachment members 230 is disposed relative to the interface member 220 in mirror symmetry about the middle plane 98.

Referring to FIG. 3, at least the first pair of attachment members 230a/230c and the second pair of attachment members 230b/230d are radially spaced apart by an angular displacement 84. Preferably, each pair of the attachment members 230 are radially spaced apart from any other pair of the attachment members 230.

Preferably, each of the attachment members 230 is biased to the respective extended position 230a/230b/230c/230d. Beneficially, biasing the attachment members 230 to the extended position 230a/230b/230c/230d adds a further biasing force on the attachment members 230, keeping the attachment members 230 in the extended positions 230a/230b/230c/230d. That is, each of the attachment members 230 is preferably biased in the respective extended position such that the attachment member will not move back into the retracted position unless the attachment member 230 is intentionally retracted by the caregiver. In some examples, a gas spring may be provided between the interface member 220 and each respective attachment member 230 to bias the attachment member 230 towards the extended position 230a/230b/230c/230d.

In some embodiments, a lock may be provided between the interface member 220 and each of the attachment members 230 to releasably lock each of the attachment members 230 in the retracted position when the device 200 is not in use. Upon releasing a lock, the respective attachment member 230 may be configured to assume the respective extended positions 230a/230b/230c/230d under the respective biasing force. Preferably, the locks are magnetic locks, for example, a permanent magnet lock or an electromagnet lock. In some alternative embodiments, each attachment member 230 may be unbarred and locked in position by sliding it into the slot 231.

In some embodiments, a controller 120 may be coupled to the actuating end 214. The controller 120 with accompanying electronics such as a battery and drivers, may be disposed on/near the base 110. Further, the controller 120 may also include a control interface such as a joystick 122, for controlling a position and an orientation of the interface member 220 and the respective attachment members 230/attachment elements 232 via the controller 120. In other words, the controller 120 is configured to move the attachment elements 232 by moving the primary member 210 and rotating the interface member 220. In an example, the joystick 122 may be a four-dimensional joystick including four switches for controlling the rotation and translation of the primary member 210 and the interface member 220. The joystick 122 may be disposed neighboring to the interface member 220 in allowing a better view and ease of use for the caregiver.

In some embodiments, one or more sensors may be disposed on the interface member in signal communication with the controller 120. The sensors may be configured to determine a distance between the interface member 220 and the patient. In some embodiments, the sensor may be a sonar sensor or laser sensor incorporated into the interface member 220 for sensing a distance between the patient and the interface member 220. The controller 120 may be configured to halt a movement of the interface member 220 responsive to the distance between the patient and the interface member 220 being below a threshold, i.e., when the interface member 220 is too close to the patient. This mitigates the risk of the interface member 220 being too close to the patient/user, and thus prevents the interface member 220 from pressing against a patient lying on the bed. The interface member 220 may be configured to resume movement when the interface member 220 has moved away from the patient and when the controller 120 determines that the distance between the interface member 220 and the patient is out of a risky range.

In some embodiments, the controller 120 may be configured with a machine learning model/machine intelligence for monitoring the state of a transfer process, to promote a safe operation. The machine intelligence may be configured to predict unforeseen circumstances or situations prior to a predicted casualty. In some embodiments, the sensors may be positioned and used by the controller 120 to determine a center of mass of the device 200, either with or without the patient. Beneficially, this allows the controller 120 to monitor a stability of the device 200 and to control the necessary force limits, speed limits, and movements constraints for avoiding accidents during the transfer process. These limits may be tuned to be patient-specific.

As illustrated in FIGS. 4 and 5, some embodiments of the apparatus 100 may include a base 110 and the device 200 coupled to the base 110. The base 110 may be an autonomous vehicular base (e.g., motorized wheelchair) or the base 110 may be pushed around manually by the caregiver. The device 200 may include a primary member 210 having an actuating end 214 and a coupling end 212 coupled to the base 110. The device 200 may be a multi-axis robotic arm or a multipleDegrees-of-Freedom (DOF) actuated linkage structure. The interface member 220 is rotatably coupled to the coupling end 214 of the primary member 210. In some embodiments, the interface member 220 may be an elongated interface member defining the first axis 92, with the interface member 220 being rotatable relative to the actuating end 214 about the first axis 92. In some embodiments, a motor or a rotational actuator may be provided coupled between the actuating end 212 and the interface member 220 to effect a controllable rotation 92′ of the interface member 220 relative to the actuating end 212 about the first axis 92.

The device 200 may further include multiple attachment members 230, for example three attachment members 230, coupled to the interface member 220. The three attachment members 230 may extend outward radially from the interface member 230 away from the first axis 92. In some embodiments, the attachment members 230 may be bars extending radially from the interface member 230. Each of the attachment members 230 may include a respective attachment element 232 for coupling to a sling 130 or a harness for a patient. In other words, the sling 130 may be coupled to the respective attachment elements 232 of the attachment members 230. The sling 130 is operable to support or hold the patient during a transfer between two supporting surfaces.

Upon a rotation 92′ of the interface member 220 relative to the actuating end 212 of the primary member 210, the attachment elements 232 are collectively rotatable about the first axis 92 relative to the actuating end 212. That is, an orientation of the sling 130 can be controlled by controlling a pose of the interface member 220. This is possible even when the sling 130 is made of a relatively soft and flexible material (for conforming to the patient). When the patient is held in the sling 130, by way of rotating 92′ the interface member 230, an inclination of the patient in the sling 130 may be varied between a relatively upright (seated) position 130a to a supine position (lying on the back) position 130b. Advantageously, this alleviates the need for two caregivers to render assistance during the process of transferring the patient between supporting surfaces, for example from a bed to a wheelchair, i.e., the apparatus 100 enables one caregiver to safely effect the assisted transfer. Advantageously, the one caregiver need only to operate the joystick 122 and does not need to risk injury to support or to stabilize the patient during the transfer process.

In some embodiments, the three attachment members 230 are spaced apart from each other along the first axis 92, in other words, each attachment member 230 is spaced apart from other attachment members 230 along the first axis 92. Preferably, two of the attachment members 230a/230b may be spaced apart radially from each other about the first axis 92, in other words, the two attachment members 230a/230b forms an angle a about the first axis 92. In other embodiments, all three attachment members 230 may be spaced apart radially from each other about the first axis 92. In some embodiments, two of the attachment elements 232a/232c or 232a/232b are spaced apart along the first axis 92. Further, two of the attachment elements 232a/232b or 232c/232b are spaced apart along a direction transverse to the first axis 92.

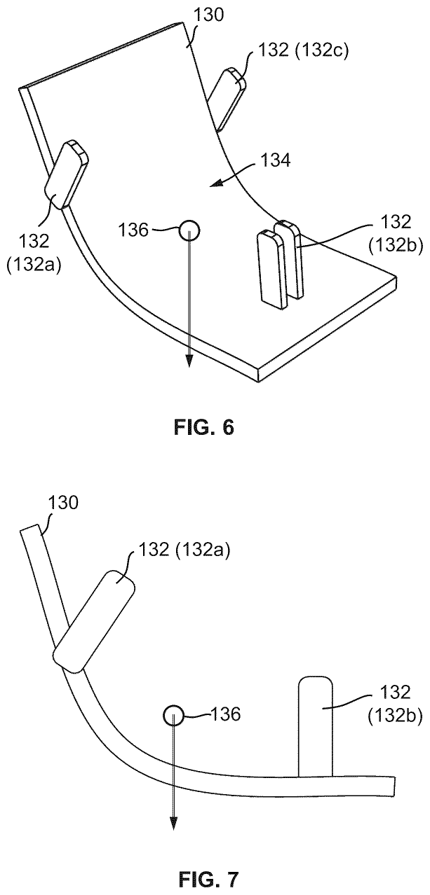

FIGS. 6 and 7 schematically illustrate one embodiment of the sling 130. The sling 130 may include attachment points 132 coupleable to the attachment elements 232. In some embodiments, the attachment points 132 of the sling 130 may define a receiving surface 134 for receiving the patient. In some examples, the sling 130 may be made from a compliant/comfortable sheet, such as a fabric sheet. In other examples, the sling 130 may provide a relatively stiff structure having a contoured surface 134 for receiving the patient. During operation of the device 200, the receiving surface 134 may be tilted upon rotation of the interface member 220 about the first axis 92.

In various embodiments, a center of mass 136 of the sling 130 may be disposed between the attachment points 132. Corresponding to the attachment elements 232, two of the attachment points 132a/132c or 132a/132b may be spaced apart along a first axis 92. Further, two of the attachment points 132a/132b or 132c/132b may be spaced apart along a second axis that is transverse to the first axis 92. The two attachment points 132a/132c may be disposed on either side of the patient. In this configuration, upon receiving the patient, a center of mass of the patient may be disposed between the the attachment points 132a/132b/132c. The device 200 can therefore be used without further adaptation by different patients of various body shapes and sizes.

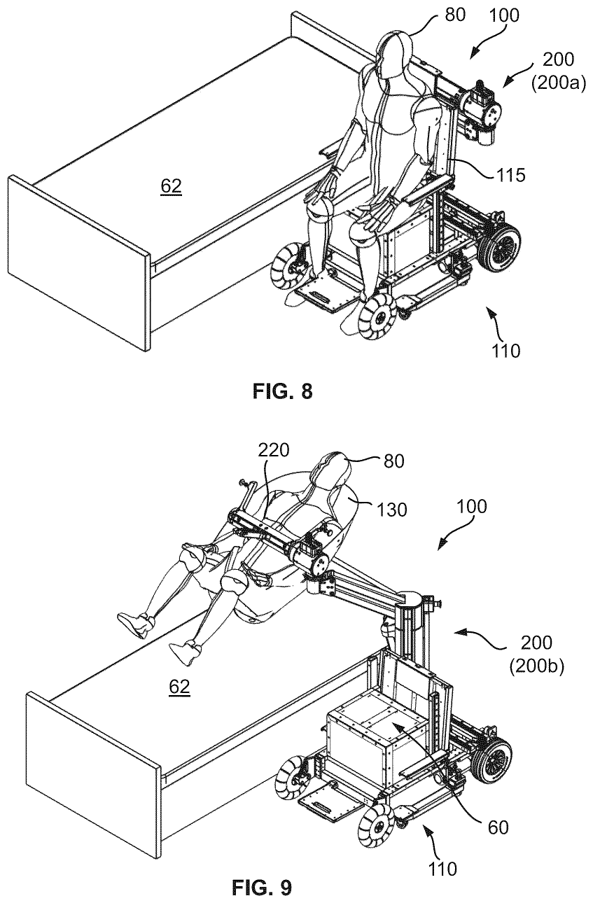

Referring to FIGS. 8 and 9, in some embodiments, the device 200 is actuatable between a folded state 200a and an operating state 200b. In the folded state 200a, the device 200 is folded for a smaller footprint. In the example illustrated in FIG. 8, the base 110 may be a wheelchair. As illustrated, in the folded state 200a, the apparatus 100 serves as a wheelchair and the device 200 does not interfere with the daily activities of the patient 80 seated on the wheelchair. In one example of a folded state 200a, as shown in FIG. 8, the device 200 may be folded and kept behind a backrest 115 of the base 110 to assume a compact configuration.

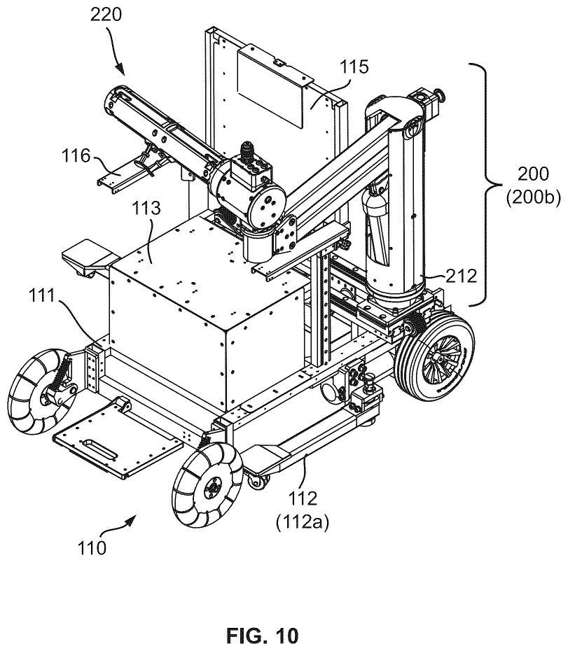

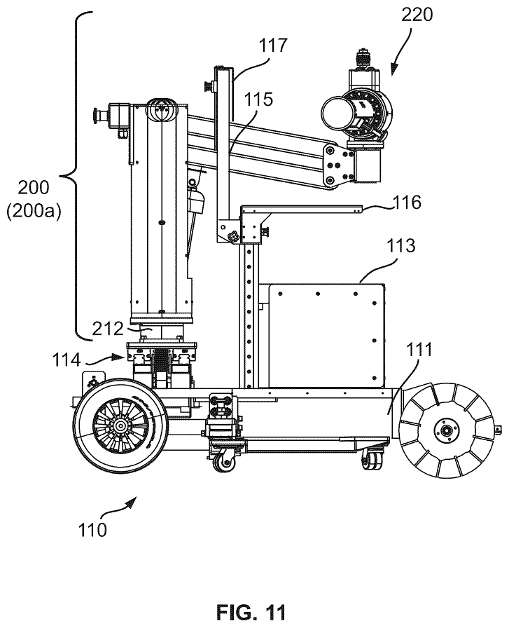

FIGS. 10 to 12 schematically illustrate an embodiment in which the apparatus 100 includes a base 110 in the form of a wheelchair. The base 110 may include a chassis 111 with a set of wheels coupled to the chassis. The two front wheels may be omni wheels for guiding and the two rear wheels may be actuated by a motor. A wheelchair seat 113 and a footrest may be part of the chassis 111. Optionally, the backrest 115 may be coupled to the chasses 111 such that the backrest 115 may be removed or displaced relative to the chassis 111. The armrests 116 may be coupled to the backrest 115 or directly to the chassis 111 such that the armrests 116 may be removed or displaced relative to the chassis 111 to reduce obstruction to the transfer process. The backrest 115 may also be tiltable for providing additional comfort of the patient during the transfer process.

In the operating state 200b, the interface member 220, is actuated to a front of the (wheelchair) base 110 such that the interface member 220 is above and in front of the seat 113. This beneficially allows the apparatus 100 to be convertible between a wheelchair for mobility and as an apparatus for transferring the patient 80 between supports. It may be appreciated that the interface member 220 may concurrently act as a protective bar or guard rail for preventing the patient 80 from falling off the sling 130.

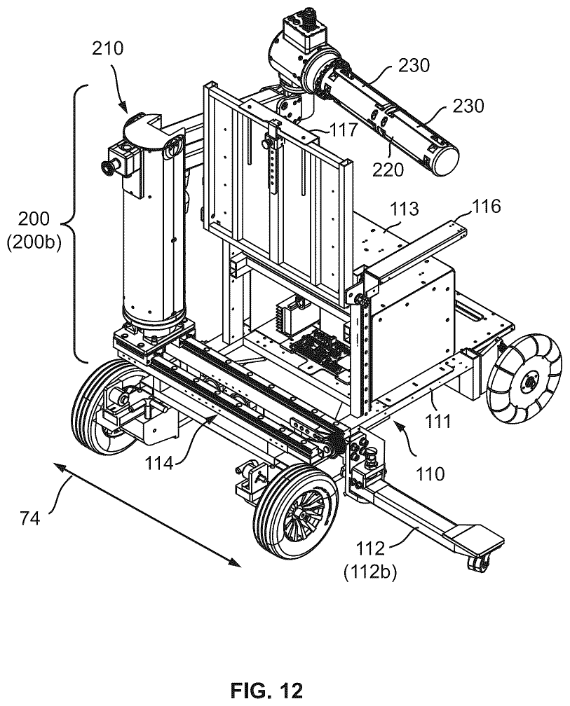

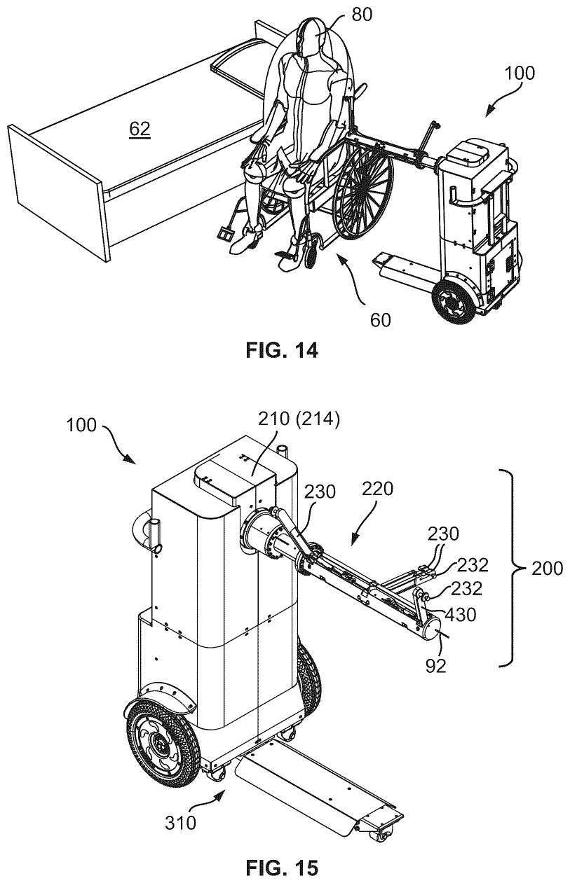

In the embodiments where the interface member 220 may be allowed to rotate about a relatively large angle relative to the secondary member 215 or relative to the primary member 210, responsive to the sensors sensing a weight contributed by a patient being at least partially supported by the sling 130, the interface member 220 is preferably constrained in its movement. Regardless of the angular range of movement enabled by the elbow 216, controller 120 is preferably configured such that the interface member 220 is in a fixed pose (orientation of the first axis 92) relative to the primary member 210 during the entire time period when the patient is fully supported by the sling 130 (e.g., when the patient is not at least partially supported by either the bed or the wheelchair). In some embodiments, the interface member 220 may be constrained to a translation (linear displacement) substantially parallel to the path 74, e.g., with the interface member 220 locked relative to the primary member 210 and with the primary member 210 constrained to a translational displacement along the path 74. The primary member 210 may be constrained by a track (as illustrated in FIG. 12) or by the wheel configuration (as illustrated in FIGS. 14 and 15).

The coupling end 212 allows the device 200 to rotate angularly 95′ about the longitudinal axis 95 of the primary member 210, whereby in conjunction with the rotation 96′ of elbow 216 about the elbow axis 96, the interface member 220 can be easily positioned above the chest of the patient. The rotation 95′ in conjunction with the rotation 96′ also enables the device 200 to be fully folded and disposed behind a backrest to have a more compact footprint for maneuver or storage (as illustrated in FIG. 8). The coupling end 212 may be slidably coupled to the base 110 such that the primary member 210 can be translated along a path 74, in which the path 74 brings the primary member 210 from one side (e.g., right side or left side) of the wheelchair (base 110) to another side of the wheelchair (base 110), traversing along the width of the wheelchair or the base 110. As one example, the coupling end 212 of the primary member 210 may be translationally driven by a belt and pulley transmission system, enabling the primary member 210 to move from one side of the wheelchair base 110 to the other side of the base along the width of the wheelchair base 110. In another example, a track 114 may be provided between the coupling end 212 and the wheelchair base 110 for allowing the device translation along the path 74. Preferably, the primary member 210 is coupled to the base 110 such that the primary member 210 can be linearly displaced along the back of the base 110.

In some embodiments, the wheelchair base 110 may include one support arm 112 coupled to one side of the wheelchair base 110. In some embodiments, two support arms 112 may be coupled to both sides of the wheelchair base 110 spaced apart by a width of the wheelchair base 110. The support arms 112 may extend along the width of the wheelchair base 110 away from the wheelchair base 110 to a respective support position 112b, thus acting as a support for the wheelchair base 110. Therefore, with the device 200 sliding/moving relative to the wheelchair base 110 along the width of the wheelchair base 110, the movement is supported by the support arm 112 in the support position 112b. In some embodiments, the support arm 112 may be pivotably coupled to the wheelchair base 110 thus allowing a movement between a folded position 112a and the support position 112b relative to the wheelchair base 110. In other embodiments, the support arm 112 may be slidable relative to the wheelchair base 110 to extend or retract from the wheelchair base 110. In some embodiments, the support arm 112 may be extended and manually locked by means of a quick-release indexing plunger in avoiding or mitigating the risk of tipping due to a shift in centre of mass when the device is transferring the patient.

The device 200 and the apparatus 100 may be used in various ways for max assist transfer or other types of transfer. The exemplary processes described herein are merely to illustrate preferred processes that require only one caregiver to perform a max assist transfer process, but do not limit the use of the device and/or the apparatus 100 to such.

The device 200 or the apparatus 100 may be brought to a docking position relative to an initial location of the patient. Preferably, the apparatus 100 is docked adjacent to an initial location of the patient. The apparatus 100 may be operable over a range of ±90 degrees with respect to a target direction of the patient. That is, the apparatus 100 may be used with the first axis 92 in any angle selected from the range of ±90 degrees. This flexibility improves accessibility and makes the apparatus more adaptable in the presence of obstacles. For instance, a washroom generally has modest space for wheelchair access. Therefore, the apparatus 100 may need to be parked perpendicular to the toilet bowl for performing the transfer process. For other applications with sufficient space, the apparatus 100 may be positioned in parallel to the patient for carrying out the transfer.

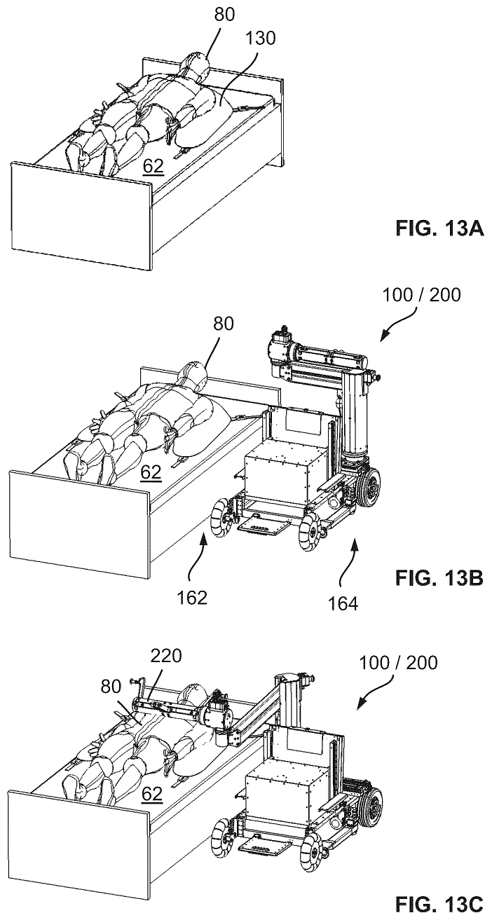

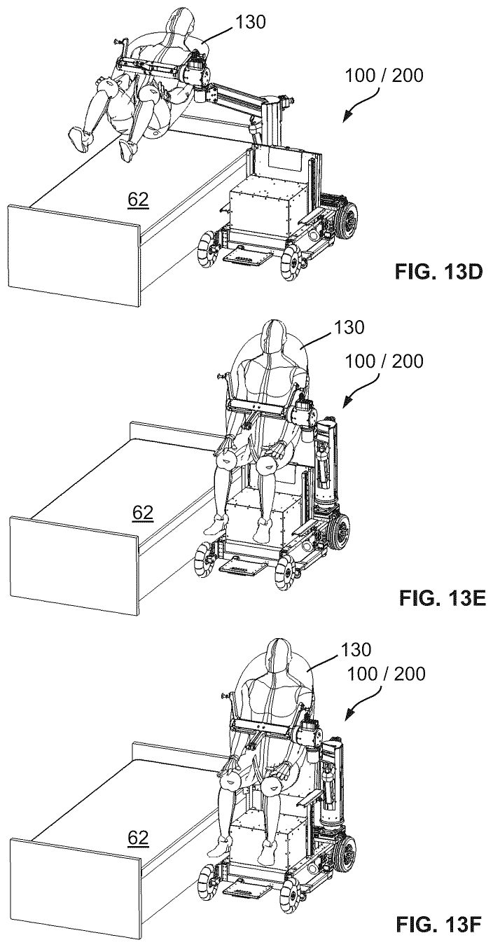

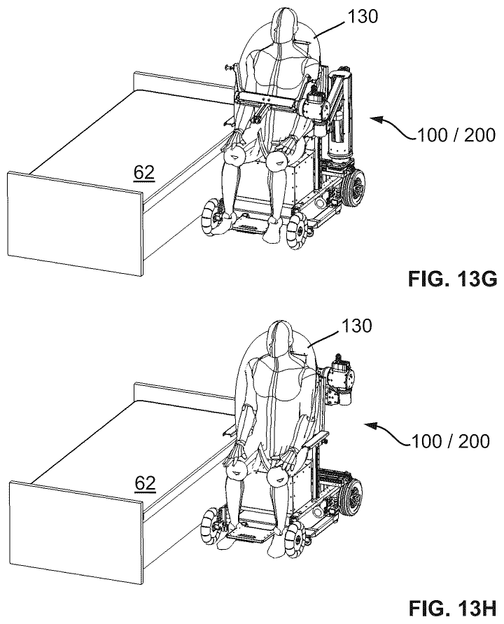

FIGS. 13A to 13H illustrates a transfer operation or a transfer process utilizing the apparatus 100 and the device 200 according to one embodiment of the present disclosure. Referring to FIG. 13A, a sole caregiver may position a sling 130 under the patient 80. As shown in FIG. 13B, the apparatus 100 is docked to one side of the bed 62. The same sole caregiver may push or drive the apparatus 100 into the docking pose. In this example, the docking pose refers to the location and orientation of the apparatus 100 in which one side of the apparatus 100 is a proximal side 162 proximal to and as close to the patient as possible. The other side of the apparatus 100 will be a distal side 164 at this stage. The apparatus 100 at this stage preferably has the respective backrest, armrest and headrest removed or lowered relative to the chassis.

As shown in FIG. 13C, the interface member 220 is positioned above and across the chest of the patient who is lying down in a supine position. The sling is secured to the attachment members of the interface member 220. Preferably, the sling is attached via the at least three attachment elements distributed along the interface member 220 (along the first axis 92), in mirror symmetry about the middle plane 98, as described above.

As shown in FIG. 13D, the primary member 210 may elevate the interface member 220 such that the patient is lifted clear of the bed and/or clear of other obstacles between the bed and the seat of the wheelchair (apparatus 100).

As shown, in moving from the pose of FIG. 13D to the pose of FIG. 13E, the interface member is rotated about the first axis 92, such that the patient is moved from a relatively tilted pose to a relatively upright pose, ready to be lowered to a seat on the wheelchair. The rotation of the interface member 220 is characterised by each of the extended attachment members and a main shaft/body of the interface member 210 being rotated together as a rigid body about its own first axis 92. The primary member 210 is translated or displaced linearly from a proximal position to a distal position relative to the apparatus 100, until the patient is above the seat of the wheelchair. While the sole caregiver is controlling the transfer using the joystick, the transfer process does not require a second caregiver to stabilize, support, or orientate the patient at this stage.

As shown in FIG. 13F, the backrest, armrest and headrest may be restored to their respective default position/original position.

As shown in FIG. 13G, the interface member 220 is lowered while maintaining the pose of the patient, until the patient is fully supported by the seat of the wheelchair.

As shown in FIG. 13H, the sling is removed and the device 200 is folded and stored behind the wheelchair. The reverse transfer process (from the wheelchair to the bed) may be performed in a reverse sequence which will be understood by persons skilled in the art. As shown in FIGS. 13C to 13G, throughout the entire transfer process, the interface member 220 can be positioned at various heights (h). For convenience, the height (h) may be taken relative to the base 110). The interface member 220 is translatable between any two heights (h) relative to the base 110 by a movement of the secondary member 215 relative to the primary member 210. In its movement between any two heights (h), the interface member 220 is preferably constrained to a translational movement parallel to the longitudinal axis 95.

FIGS. 14 and 15 illustrate another embodiment of the apparatus 100. In this embodiment, the apparatus 100 may be configured as an independent unit without a support surface, i.e., without a seat, to transfer a patient 80 from a first surface 60, such as a wheelchair, to a second surface 62, such as a bed. Similarly, the apparatus 100 may include a base 110 and a device 200 coupled to the base 110. The device 200 may include a primary member 210 coupled to the base 110, this allowing the device 200 to be moveable relative to the base 110. As an example, the primary member 210 may allow a translation of the device 200 relative to the base 110 for adjustment of a height of the device. The device 200 may further include an elongated interface member 220 rotatably coupled to an actuating end 214 of the primary member 210. The interface member 220 is rotatable relative to the actuating end 214 about a first axis 92. Multiple attachment members 230, such as four attachment members 230, may extend outward radially from the interface member 220 away from the first axis 92. Each of the attachment members provides a respective attachment element 232 for coupling to a sling, wherein the attachment elements 232 are collectively rotatable about the first axis 92 relative to the actuating end 214 responsive to a rotation of the interface member 220.

Disclosed herein is a device 200 and an apparatus 100 for transferring a patient or an immobilized user between two support surfaces. The transfer process may include the steps of lifting, moving, and putting down the patient in a safe and secure manner. The device 200 reduces the number of caregivers required as well as alleviating the physical demands for the caregiver during the patient transfer process. In particular, as described above, the present device 200 and/or apparatus 100 renders the presence of a second caregiver (for the purpose of stabilizing or supporting the patient when the patient is fully supported by the apparatus 100) as redundant or optional. The device 200 may include multiple actuated joints, providing a larger workspace and flexibility in assisting the sole caregiver and overcoming challenges from home setting (such as bathrooms, bedrooms) such as overcrowding due to the need to accommodate the patient, the caregivers, and devices. Further potential locations of use include hospital ward, washroom, or the carpark. The device 200 or the apparatus 100 is not limited to transferring a patient between a wheelchair and a patient bed, but may also be employed for other situations such a toilet bowl and a car seat.

In some embodiments, the device may be modular and adaptable for various existing bases, such as a wheelchair. This enables a dual functionality with the combination of the wheelchair and the transfer device. Advantageously, this achieves space saving and improves operational effectiveness. In comparison to conventional devices which may only assist in partially dependent patients, the disclosed device allows assistance to be rendered to fully dependent patients who require assistance in the transfer process from a lying position/supine position, with minimal assistance required from the caregiver.

Alternatively described, the present disclosure describes an apparatus for assisting a patient, the apparatus includes: a base, a primary member, an interface member, and three or more attachment members. The primary member is coupled to the base at a coupling end, with the primary member extending along a longitudinal axis from the coupling end to a shoulder. The interface member is an elongate member defining a first axis. The interface member is coupled to the shoulder with the first axis extending transversely relative to the primary member. The three or more attachment members are coupled to the interface member and extendable to extend radially from the interface member. Each of the three or more attachment members is attachable via corresponding attachment elements to a sling. The three or more attachment elements and the interface member are collectively rotatable as a rigid body about the first axis.

Preferably, the interface member is substantially parallel to the base at all times or substantially orthogonal to the longitudinal axis at all times. The apparatus preferably includes a secondary member coupling the interface member to the shoulder. The interface member is preferably coupled to a far end of the secondary member, with the secondary member extending from the shoulder to the far end. The interface member is preferably translatable between any two heights relative to the base by a movement of the secondary member relative to the primary member. Preferably, the interface member is constrained to a translational movement parallel to the longitudinal axis in moving between the any two heights.

Preferably, at least three of the three or more attachment members are distributed along the first axis. Preferably, four of the three or more attachment members are disposed in pairs in mirror symmetry about a middle plane of the interface member. Preferably, the three or more attachment members are coupled with the interface member and biased towards an extended position, the extended position of any one of the three or more attachment members being one in which the one of the three of more attachment members is extended radially from the interface member. Preferably, the three or more attachment members are displaceable between an extended position and a retracted position, wherein in the retracted position, a respective one of the three or more attachment members is at least partially received in a respective slot of the interface member.

Preferably, each of the three or more attachment members is releasably lockable in the retracted position. Preferably, the corresponding attachment elements are spaced apart from one another along the first axis. Optionally, the corresponding attachment elements are radially spaced apart from one another about the first axis. In some embodiments, the corresponding attachment elements are spaced apart along the first axis, wherein at least two of the corresponding attachment elements are spaced apart from one another along a second axis, the second axis transverse to the first axis.

The apparatus may include a sling coupled to the corresponding attachment elements to define a receiving surface to receive the patient, wherein a rotation of the interface member provides a corresponding tilt of the receiving surface. Preferably, the sling includes attachment points coupled to the corresponding attachment elements, and wherein a center of mass of the sling is disposed between the attachment points.

Preferably, the apparatus further includes a controller in signal communication with the primary member, wherein the controller is configured to move the corresponding attachment elements by moving the primary member along a path and/or rotating the interface member. The apparatus includes at least one sensor in signal communication with the controller, wherein the at least one sensor is configured to determine a distance between the interface member and the patient, and wherein responsive to the distance being below a threshold, the controller halts displacement of the attachment elements.

Preferably, the base includes a first support surface, the base being coupled to and supporting the primary member, wherein the apparatus is dockable relative to a second support surface. Preferably, the primary member is constrained to a translational displacement along a path. Preferably, the primary member is moveable between a proximal side and a distal side of the base, relative to the second support surface. In some embodiments, the primary member is coupled to a track extending between the proximal side and the distal side of the base. In some embodiments, a coupling end of the primary member is slidably coupled to the base to move along a width of the base, wherein a movement in the primary member is supported by the at least one support arm in the support position. In some embodiments, the at least one support arm is pivotably coupled to the base to move between a folded position and the support position, relative to the base.

Preferably, the apparatus is actuatable between an operating state and a folded state, wherein in the folded state, the interface member is disposed at a back of the base. Preferably, the base includes a wheelchair.

All examples described herein, whether of apparatus, methods, materials, or products, are presented for the purpose of illustration and to aid understanding, and are not intended to be limiting or exhaustive. Modifications may be made by one of ordinary skill in the art without departing from the scope of the invention as claimed.

1. An apparatus for assisting a patient, the apparatus comprising:
a base;
a primary member coupled to the base at a coupling end, the primary member extending along a longitudinal axis from the coupling end to a shoulder;
an interface member, the interface member being an elongate member defining a first axis, the interface member being coupled to the shoulder with the first axis extending transversely relative to the primary member; and
three or more attachment members, the three or more attachment members being coupled to the interface member and extendable to extend radially from the interface member, each of the three or more attachment members being attachable via corresponding attachment elements to a sling, wherein the three or more attachment elements and the interface member are collectively rotatable as a rigid body about the first axis.

2. The apparatus as recited in claim 1, further comprising: a secondary member coupling the interface member to the shoulder; and an elbow, the elbow coupling the interface member to a far end of the secondary member, the secondary member extending from the shoulder to the far end, wherein in operation the elbow is configured to rotate the interface member relative to the secondary member with the interface member being parallel relative to the base.

3. The apparatus as recited in claim 2, wherein the interface member is translatable between any two heights relative to the base by a movement of the secondary member relative to the primary member.

4. The apparatus as recited in claim 3, wherein the interface member is constrained to a translational movement parallel to the longitudinal axis in moving between the any two heights.

5. The apparatus as recited in claim 1, wherein at least three of the three or more attachment members are distributed along the first axis, and wherein the at least three of the three or more attachment members are spaced apart from one another relative to the first axis.

6. The apparatus as recited in claim 1, wherein four of the three or more attachment members are disposed in pairs in mirror symmetry about a middle plane of the interface member.

7. The apparatus as recited in claim 1, wherein the three or more attachment members are coupled with the interface member and biased towards an extended position, the extended position of any one of the three or more attachment members being one in which the one of the three of more attachment members is extended radially from the interface member.

8. The apparatus as recited in claim 1, wherein the three or more attachment members are displaceable between an extended position and a retracted position, and wherein in the retracted position, a respective one of the three or more attachment members is at least partially received in a respective slot of the interface member, and wherein each of the three or more attachment members is releasably lockable in the retracted position.

9-11. (canceled)

12. The apparatus as recited in claim 1, wherein the corresponding attachment elements are spaced apart along the first axis, and wherein at least two of the corresponding attachment elements are spaced apart from one another along a second axis, the second axis transverse to the first axis.

13. The apparatus as recited in claim 1, further comprising the sling coupled to the corresponding attachment elements to define a receiving surface to receive the patient, wherein a rotation of the interface member provides a corresponding tilt of the receiving surface.

14. The apparatus as recited in claim 13, wherein the sling includes attachment points coupled to the corresponding attachment elements, and wherein a center of mass of the sling is disposed between the attachment points.

15. The apparatus as recited in claim 1, further comprising:
a controller in signal communication with the primary member, wherein the controller is configured to move the corresponding attachment elements by moving the primary member along a path and/or rotating the interface member; and
at least one sensor in signal communication with the controller, wherein the at least one sensor is configured to determine a distance between the interface member and the patient, and wherein responsive to the distance being below a threshold, the controller is configured to halt displacement of the attachment elements.

16. (canceled)

17. The apparatus as recited in claim 1, wherein the base comprises a first support surface, the base being coupled to and supporting the primary member, wherein the apparatus is dockable relative to a second support surface.

18. The apparatus as recited in claim 17, wherein the primary member is constrained to a translational displacement along a path.

19. The apparatus as recited in claim 17, wherein the primary member is moveable between a proximal side and a distal side of the base, relative to the second support surface.

20. The apparatus as recited in claim 19, wherein the primary member is coupled to a track extending between the proximal side and the distal side of the base.

21. The apparatus as recited in claim 17 wherein the coupling end of the primary member is slidably coupled to the base to move along a width of the base, wherein a movement in the primary member is supported by at least one support arm in a support position.

22. The apparatus as recited in claim 21, wherein the at least one support arm is pivotably coupled to the base to move between a folded position and the support position, relative to the base.

23. The apparatus as recited in claim 1, wherein the apparatus is actuatable between an operating state and a folded state, wherein in the folded state, the interface member is disposed at a back of the base.

24. The apparatus as recited in claim 1, wherein the base comprises a wheelchair.
